(19) United States
(12) Patent Application Publication
(10) Pub. No.: US 2009/0248446 A1
(43) Pub. Date: Oct. 1, 2009

(54) Medical information card

(76) Inventors: Stacey L. Grigsby, Louisville, KY (US); David Brown, Fisherville, KY (US)

Correspondence Address: David W. Carrithers;CARRITHERS LAW OFFICE, PLLC, Suite 206, 6200 Dutchmans Lane, Louisville, KY, 40205, US

(21) Appl. No.: 12/384,042

(22) Filed: Mar. 31, 2009

Related U.S. Application Data
(60) Provisional application No. 61/072,512, filed on Mar. 31, 2008.

(51) Int. Cl. G06Q 50/00

(52) U.S. Cl. 705/3

(57) ABSTRACT

A device for storing, transporting and maintaining a user's medical history and condition. The device comprises a flash drive which is preprogrammed with a form ready to be filled out, edited or appended with all of the user's medical information. The form is in OMNIFORM® mailable filler format commonly used in the medical industry.

This application claims priority from U.S. Provisional Application No. 61/072,512 filed on Mar. 31, 2008.

### TECHNICAL FIELD

The present invention relates to the field of medical information storage, maintenance and retrieval.

### DESCRIPTION OF THE RELATED ART

U.S. Pat. No. 6,733,329 by Yang for “USB FLASH DRIVE” which issued on May 11, 2004 teaches a mobile data storage device which stores hundreds of megabytes of data, can easily be connected to a computer and easily fits in the user's pocket.

Some medical offices have a small touch screen computer which the patient must use to answer the questions posed. This information remains in the office of the medical professional.

Many facilities still use multi-page questionnaires filled out by the patient, regarding illnesses, treatments and all medications which the patient takes or has taken

### BACKGROUND OF THE INVENTION

Yang teaches a flash drive but doesn't show how it(nay be used to store an ongoing medical history for a user.

As stated above, upon entering many hospitals or medical specialist facilities, a patient is required to fill out a multi-page questionnaire regarding his medical history. Such a questionnaire is sometimes mailed to the patient in advance of an appointment. There are a number of these forms on the market. Or a small touch screen computer has appeared for use by the patient. All information for the foregoing types of prior art remain the property of the medical professional.

A device is needed which can be easily carried on one's person, will allow storage and retrieval of one's entire medical history, and will be the property of the user.

A device as described in the preceding paragraph, the Medical Information Card (or MICARD) is disclosed in the present invention. The MICARD comprises an external computer memory device known as a flash drive which can be purchased at most office supply stores. It is preprogrammed with a medical history form created in Omniform® Version 5.1. Omniform® is a registered trademark of Scansoft, INC.

The MICARD is meant to be updated anytime a new diagnosis, treatment or medication is prescribed. In addition, the MICARD can be inserted in a computer even if the patient is brought to an emergency room unconscious. Most importantly, the MICARD and its information remain in the possession of the owner and not in any particular office.

Ideally, the MICARD should be instituted at birth and be a lifelong companion to its owner. However, use of the MICARD can be started at any age.

### SUMMARY OF THE INVENTION

The Medical Identification Card (MICARD ) is an autobiographical medical history of the owner's wellness or lack thereof. When plugged into a computer's USB port, the computer can be made to print out a complete up to date medical history. The MICARD is a small easy to carry item. It should be protected from magnetic fields such as found in airports, courthouses, or magnets. Since the MICARD is the property of its owner, it can travel with the owner.

It is an object of this invention to provide a medical information storage device which is small and easily carried with the user when needed or on a permanent basis.

It is an object of this invention to provide a medical information storage device which can be used to quickly and easily give medical personnel the accurate information needed to treat a patient who is merely visiting a clinic or may be in need of emergency medical attention.

It is an object of this invention to provide a medical information storage device which is compatible with computer systems used in most medical facilities.

It is an object of this invention to provide a medical information storage device which is easily distinguishable from other flash drives.

The present invention teaches a device called a Medical Information Card (MICARD), which will read, write; and retain an individual's complete medical history. It is a computer-compatible device small enough to fit conveniently in a pocket or purse.

This device consists of around eight gigabytes of memory in a flash drive, which is preprogrammed to ask necessary medical questions and provide space for answers, so that when said device has been loaded with an individual's medical history it is a virtual autobiography of the individual's well being. The flash drive is programmed using OMNIFORM Version 5.1. OMNIFORM is a trademark of Scansoft, INC.

Such a flash drive with the unique computer program is compatible with current computers, and will store enough information for the life of the patient. Data entry and retrieval for this device does not require special expertise. An office worker with average computer skills can complete the medical history for a patient with a minimum of time and effort, Retrieval of information from the device can be accomplished with equal ease.

The Medical Information Card (MICARD) requires no power source other than a computer into which it is plugged during use. This device remains the property of the person whose history it contains.

Advantage: This invention will allow the patient to present their medical information upon arrival at the office of a medical professional or a hospital. The medical device can be read by a computer, and the patient's complete medical history will be printed, even if the patient is unconscious in a hospital emergency room or otherwise unable to assist in providing medical history.

This information can be completed when an individual is well and comfortable rather than when he is ill or nervous in a medical facility. Changes such as subsequent illnesses and additions and deletions of prescription medications can easily be made at anytime.

As people age, it frequently becomes more difficult to remember illnesses and treatments than when they were younger. Heart attacks, strokes and various forms of mental deterioration add to confusion regarding past health matters. Therefore, utilization of this medical device should be started for children, by their parents, and it should be a lifelong companion to its owner.

The computer printout, which is a result of this device, can significantly increase both the speed and quality of treatment by a medical professional, since they are likely to have a comprehensive view of the patient's health history and have it in a timely manner. The plastic handle of this device is emblazoned with a caduceus in order that its owner and medical personnel can easily determine the nature of said device. This has been done to eliminate confusion with other types of flash drives which are routinely carried by an ever increasing number of people. This device is owned by the patient and should be kept by the patient at all times. Accidents are never planned.

Disadvantages: This medical memory device will cost more than the multi-page questionnaire currently in use by most medical professionals; however, it is conceivable that it will last a lifetime. The device must not be subjected to the magnetic field of a magnetometer, such as those found in airports and court houses, since such a magnetic field will erase the information stored in this device.

### BRIEF DESCRIPTION OF THE DRAWINGS

A better understanding of the present invention will be had upon reference to the following description in conjunction with the accompanying drawings in which like numerals refer to like parts throughout the views wherein:

FIG. 1 is a view of Page 1 of the preprogrammed form within the MICARD.

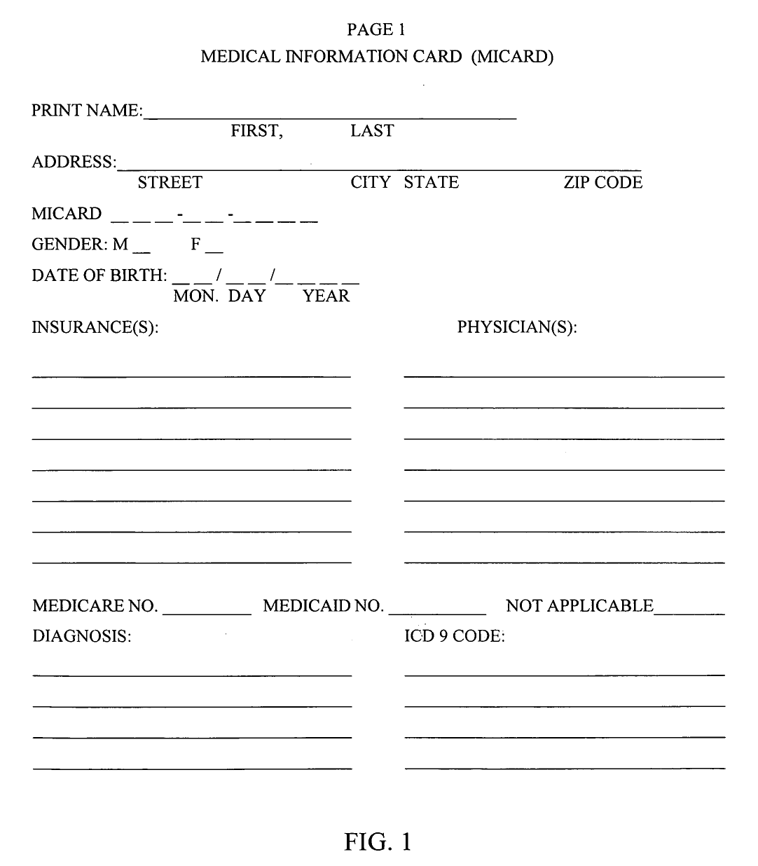

FIG. 2 is a view of Page 2 of the preprogrammed form within the MICARD.

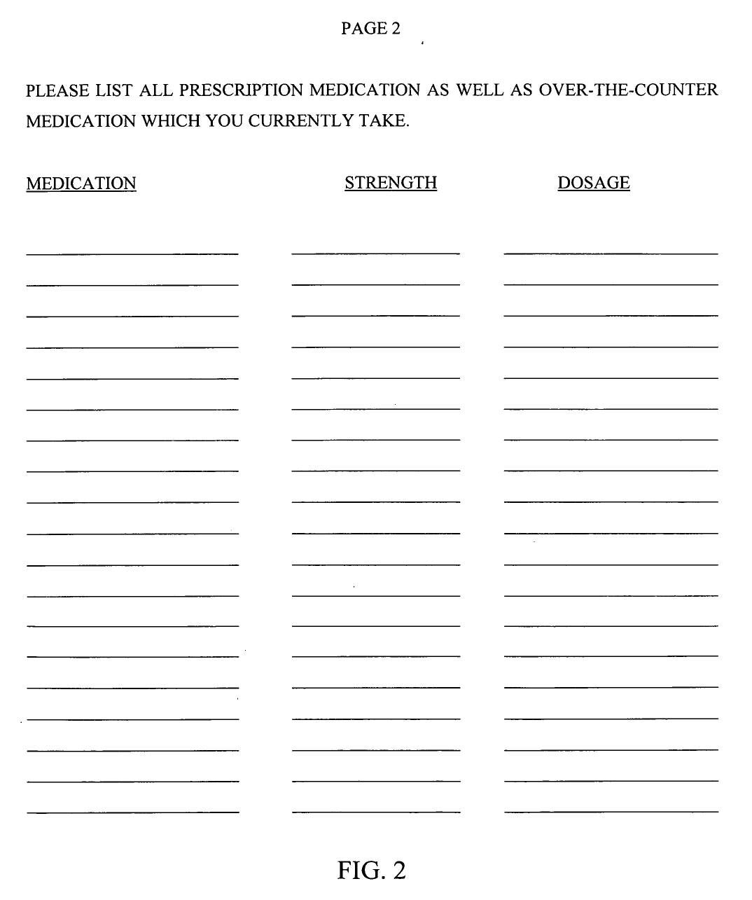

FIG. 3 is a view of Page 3 of the preprogrammed form within the MICARD.

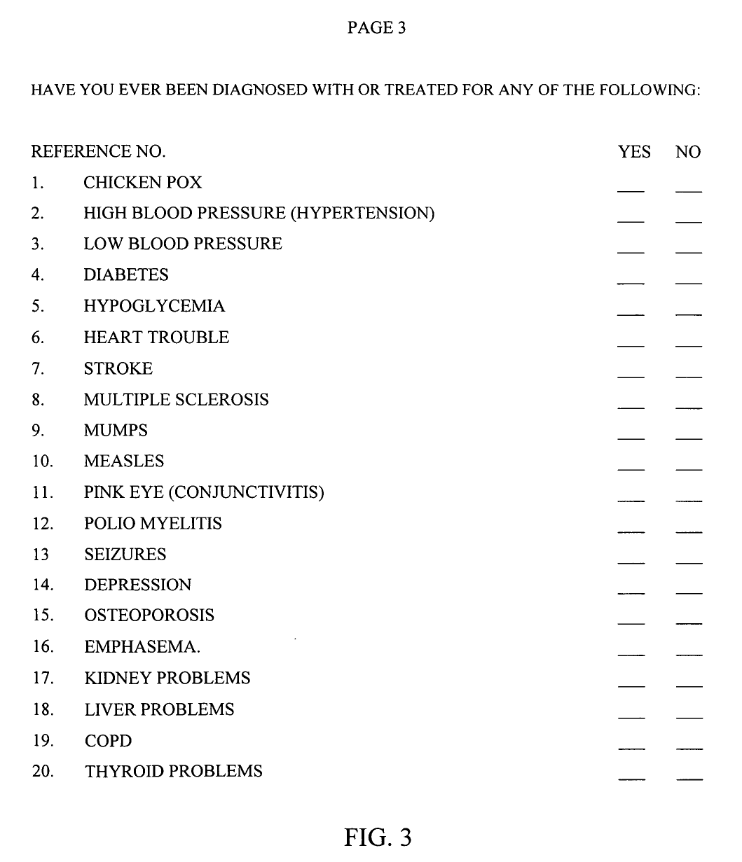

FIG. 4 is a view of Page 4 of the preprogrammed form within the MICARD.

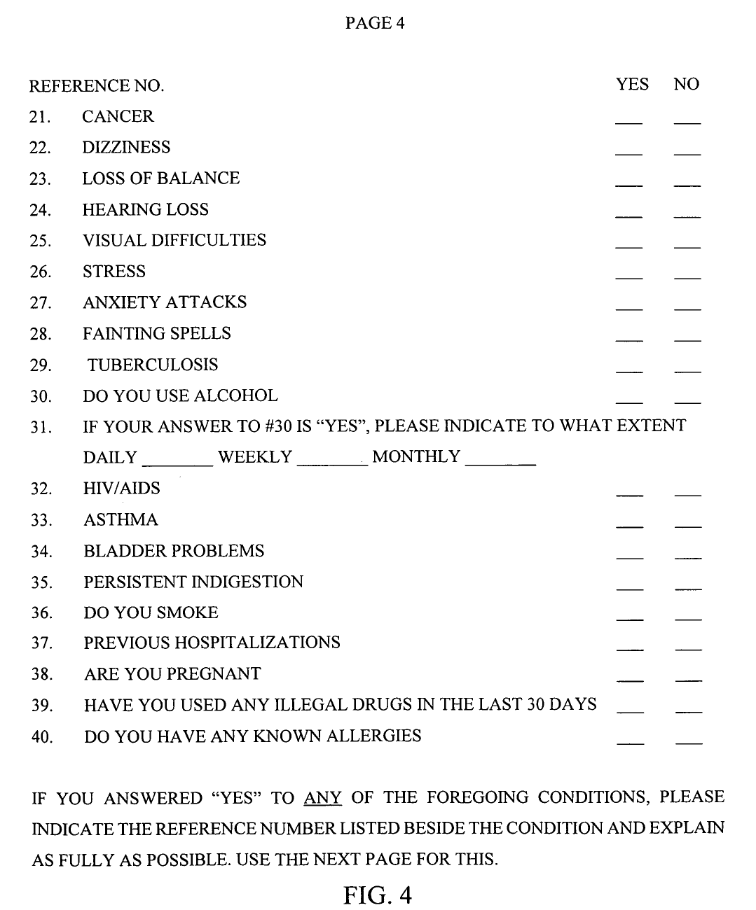

FIG. 5 is a view of Page 5 of the preprogrammed form within the MICARD.

FIG. 6 is a view of Page 6 of the preprogrammed form within the MICARD.

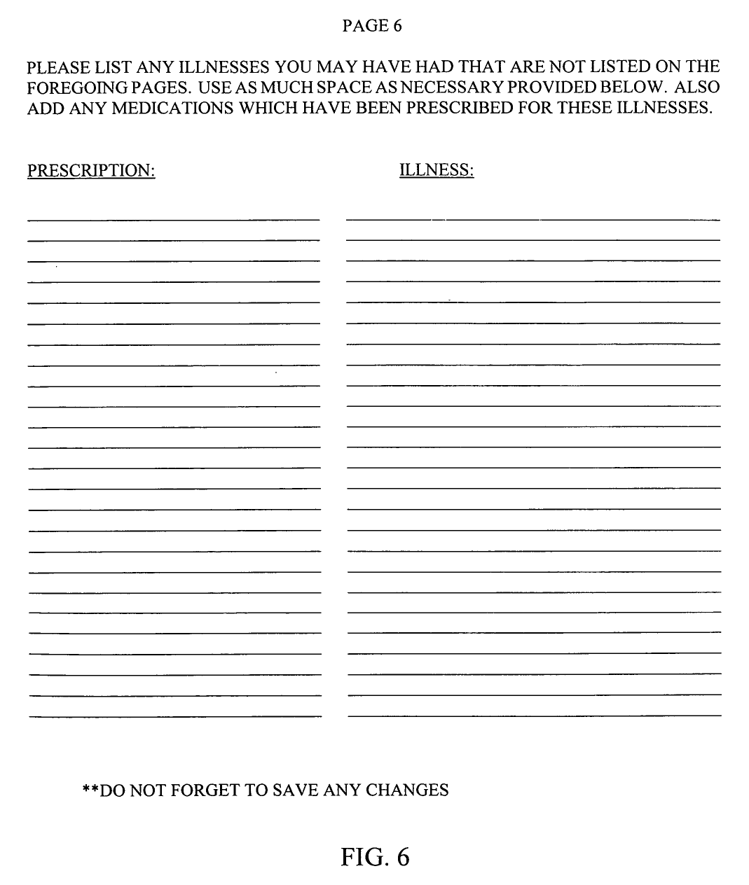

FIG. 7 is a view of the MICARD flash drive showing the caduceus.

### DESCRIPTION OF THE PREFERRED EMBODIMENTS

In accordance with the present invention, there is provided a flash drive preprogrammed with a six page form in OMNIFORM® format. Each page may contain either or all text, fill text, combination an/or check boxes. The MICARD has a minimum of six pages with as many additional pages as are necessary for added information. Each page is formatted with these parameters: Size 11″ high; 8½″ wide; 1″ top margin; 1″ left margin; ¾″ right margin and ¾″ bottom margin. Pages are in portrait orientation.

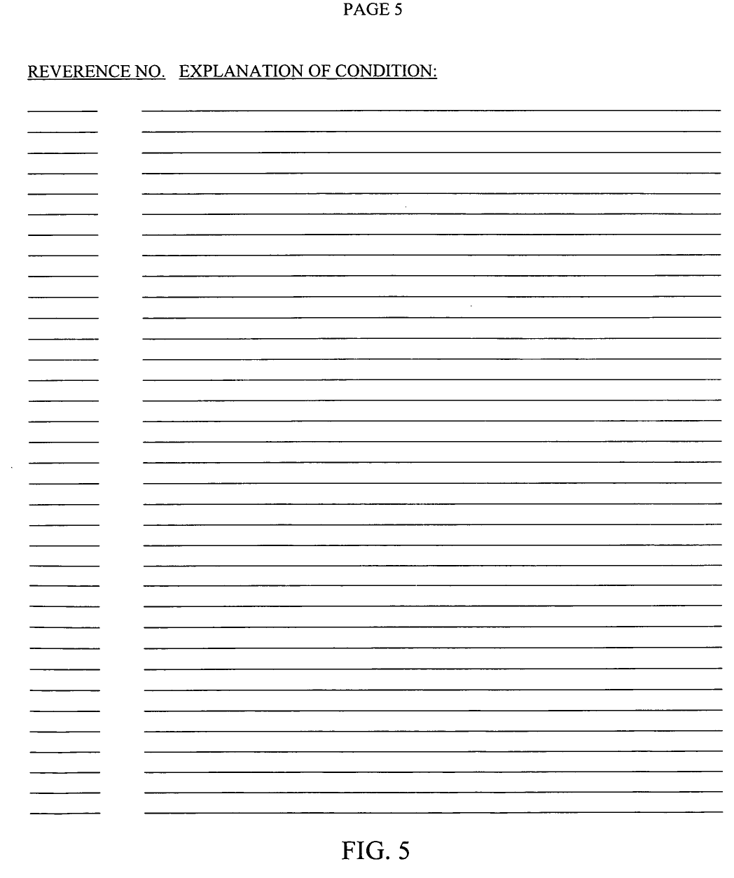

Each page starts out as a blank formatted form. The first formatted page, shown in FIG. 5, requires the name, address, MICARD number, date of birth, gender, insurances(s), physician(s), medicare number, medicaid number, non-applicability thereof, diagnosis and ICD 9 code.

The second formatted page requests that the patient list all prescriptions as well as over the counter medication which he currently takes, as well as the strength and dosage of medication(s). Spaces are provided for answers to the questions asked.

The third and fourth pages list a number of health problems and asks if the patient has ever had these or other health problems. All pages beginning with page three have a reference number to the left of listed illnesses. The reference number is to be used on subsequent pages when additional explanation is required.

Page five and all subsequent pages are for further explanation of any medical problems or for those not listed theretofore. The listed questions are not meant to be all inclusive.

The finishing step is to save the form in mailable filler. This will allow any WINDOWS® based computer to open the form. Copy the two files that are created after saving it as mailable filler, (MICARD.exe and MICARD.html) to the flash drive.

The MICARD is loaded by a data-entry person in a hospital or other medical facility. It remains the property of its owner and is small enough to be easily carried in a pocket, purse, or on a key chain. It can easily be distinguished form other flash drives due to the fact that the outside cover of the MICARD is emblazoned with a ‘caduceus’ medical symbol.

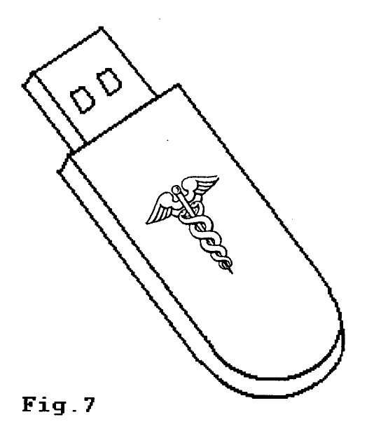

As shown in FIG. 7, enclosure 10 is emblazoned on one side with caduceus 20 to help distinguish the MICARD from any other flash drive a user may have.

The foregoing detailed description is given primarily for clearness of understanding and no unnecessary limitations are to be understood therefrom, for modification will become obvious to those skilled in the art upon reading this disclosure and may be made upon departing from the spirit of the invention and scope of the appended claims. Accordingly, this invention is not intended to be limited by the specific exemplification presented herein above. Rather, what is intended to be covered is within the spirit, and scope of the appended claims.

I claim:

1. A medical information storage device comprising;
a flash drive having around eight giga-bytes of memory storage;
a form preprogrammed within containing six pages listing the user's name, address, Storage device reference number, date of birth, gender, insurances(s), physician(s), medicare number, medicaid number, non-applicability thereof, diagnosis and ICD 9 code;
said form preprogrammed in a common medical format; and
an enclosure containing identifying indicia on a front side.

2. The medical information storage device as in claim 1 wherein said medical format is the OMNIFORM® format.

3. The medical information storage device as in claim 1 wherein said indicia is a caduceus symbol affixed onto said enclosure.

4. The medical information storage device as in claim 1 wherein said indicia is a caduceus symbol embossed into said enclosure.

5. A method of using a medical information card comprising the steps of:
receiving said card from a patient;
connecting said card into a computer capable of interfacing with the OMNIFORM® format;
inputting patient medical information as needed;
outputting data needed for medical treatment as needed;
inputting diagnostic and medicinal data as needed;
printing data as needed;
disconnecting said card from said computer; and
returning said card to said patient.
